(19) United States
(12) Patent Application Publication
(10) Pub. No.: US 2013/0099914 A1
(43) Pub. Date: Apr. 25, 2013

(54) APPARATUS AND METHOD FOR CONTROLLING SPEEDOMETER FOR VEHICLE

(71) Applicants: Dae-Sub Yoon, Daejeon (KR); Yoon-Sook Hwang, Gyeongsangbuk-Do (KR); Jong-Woo Choi, Daejeon (KR); Hye-Sun Park, Daejeon (KR); Jong-Hyun Park, Daejeon (KR); Kyong-Ho Kim, Daejeon (KR)

(72) Inventors: Dae-Sub Yoon, Daejeon (KR); Yoon-Sook Hwang, Gyeongsangbuk-Do (KR); Jong-Woo Choi, Daejeon (KR); Hye-Sun Park, Daejeon (KR); Jong-Hyun Park, Daejeon (KR); Kyong-Ho Kim, Daejeon (KR)

(73) Assignee: ELECTRONICS AND ELECOMMUNICATIONS RESEARCH INSTITUTE, Daejeon-City (KR)

(21) Appl. No.: 13/585,506

(22) Filed: Aug. 14, 2012

(30) Foreign Application Priority Data
Oct. 19, 2011 (KR) KR10-2011-0107123
Apr. 26, 2012 (KR) KR10-2012-0043844

(51) Int. Cl. B60Q 1/00

(52) U.S. Cl. 340/441

(57) ABSTRACT

The apparatus includes an information collection unit configured to collect map information, information about the position of a vehicle, and base station information, a speed limit calculation unit configured to calculate a legal speed limit of a road on which the vehicle is driving, based on the map information, the information about the position, and the base station information, a speedometer display mode storage unit configured to store a number of differently set speedometer display modes for respective legal speed limits of the road, a speedometer display mode extraction unit configured to extract a speedometer display mode corresponding to the legal speed limit of the road among the number of differently set speedometer display modes depending upon the legal speed limit of the road, and a display unit configured to automatically change a previously displayed speedometer display modes to the extracted speedometer display mode.

### CROSS-REFERENCES TO RELATED APPLICATIONS

This application claims priority to Korean Patent Application Nos. 10-2011-0107123 and 10-2012-0043844, filed on Oct. 19, 2011 and Apr. 26, 2012, which are incorporated herein by reference in its entirety.

### BACKGROUND OF THE INVENTION

1. Field of the Invention

Exemplary embodiments of the present invention relate to an apparatus and method for controlling a speedometer for a vehicle; and, particularly, to an apparatus and method for controlling a speedometer which calculates a speed limit for a vehicle on a road on which the vehicle is running, based on information about the position of a vehicle of interest, and automatically changes a display mode of the speedometer based on the speed limit to prevent a driver from driving fast for the purpose of safe driving.

2. Description of Related Art

A speedometer is a gauge that measures and displays the speed of a vehicle driving on a road. Many modern speedometers are electronic. A rotation sensor mounted in the transmission sends a series of electronic pulses at intervals corresponding to a rotational speed of a driveshaft. A computer converts the pulses to a speed and displays the speed on an electronically controlled analog-type needle or a digital display.

FIG. 1 illustrates an analog-type speedometer with a needle. Marks on the speedometer typically include numbers and large and small gradation marks. The large gradation marks are often associated with speeds such as 20, 40, 60, 80 km/h, etc., while the small gradation marks typically equally divide the space between the large gradation marks, by 2 or 10, for example.

For the analog-type speedometer, there is a likelihood that a driver may judge that the driver is not driving too fast if the needle points toward the right side, with a reference value (120 km/h) or an intermediate value (120 km/h) being centered, or if the needle points toward the left side. That is, the driver does not accurately judge the driving speed of the vehicle by looking at the analog-type speedometer displayed, but determines the approximate driving speed by referring to the position of the needle. Furthermore, the driver may erroneously judge whether he or she is driving safely by comparing her or his vehicle with other vehicles driving on the road, rather than on the basis of the accurate driving speed.

### SUMMARY OF THE INVENTION

An embodiment of the present invention is directed to an apparatus and method for controlling a speedometer for a vehicle which can calculate a speed limit for a vehicle on a road on which the vehicle is running, based on information about the position of a vehicle of interest, and automatically change a speedometer display mode based on the speed limit to prevent a driver from driving fast for the purpose of safe driving.

Other objects and advantages of the present invention can be understood by the following description, and will become apparent with reference to the embodiments of the present invention. Also, it will be obvious to those skilled in the art to which the present invention pertains that the objects and advantages of the present invention can be realized by the means as claimed and combinations thereof.

In accordance with an embodiment of the present invention, an apparatus for controlling a speedometer for a vehicle includes an information collection unit configured to collect map information, information about the position of a vehicle, and base station information; a speed limit calculation unit configured to calculate a legal speed limit of a road on which the vehicle is driving, based on the map information, the information about the position, and the base station information; a speedometer display mode storage unit configured to store a number of differently set speedometer display modes for respective legal speed limits of the road; a speedometer display mode extraction unit configured to extract a speedometer display mode corresponding to the legal speed limit of the road among the number of differently set speedometer display modes for respective legal speed limits of the road; and a display unit configured to automatically change a previously displayed speedometer display mode to the extracted speedometer display mode.

The differently set speedometer display modes for respective legal speed limits of the road may include different intermediate values from one another.

The differently set speedometer display modes for respective legal speed limits of the road may include different intervals of graduation marks.

The differently set speedometer display modes for respective legal speed limits of the road include different background colors.

The map information may be information about a map including a road on which the driving vehicle is positioned, and the base station information may be information about a base station which wirelessly communicates with the vehicle.

In accordance with another embodiment of the present invention, a method for controlling a speedometer for a vehicle includes collecting map information, information about the position of a vehicle, and a base station information; calculating a legal speed limit of a road on which the vehicle is driving, based on the map information, the information about the position, and the base station information; extracting a speedometer display mode corresponding to the legal speed limit of the road among the number of differently set speedometer display modes depending upon the legal speed limit of the road; and automatically changing a previously displayed speedometer display mode to the extracted speedometer display mode to display the speedometer display mode.

With the configuration of the present invention, since the apparatus and method for controlling the speedometer calculates the speed limit for the vehicle on the road on which the vehicle is running, based on the information about the position of the vehicle of interest, and automatically changes the display mode of the speedometer based on the speed limit to display it, it is possible to prevent the driver from driving fast for the purpose of safe driving.

In addition, according to the embodiment, it is possible to prevent the driver from driving beyond the speed of the intermediate value, thereby naturally following the legal speed limit.

### BRIEF DESCRIPTION OF THE DRAWINGS

FIG. 1 is a diagram illustrating an analog-type speedometer of the related art;

FIG. 2 is a block diagram illustrating an apparatus for controlling a speedometer according to an embodiment of the present invention;

FIG. 3 is a flowchart illustrating a method for controlling a speedometer according to an embodiment of the present invention;

FIG. 4 is a diagram illustrating an application to which a method for controlling a speedometer according to an embodiment of the present invention is applied; and

FIGS. 5 to 7 are diagrams illustrating a speedometer of which a display mode is changed depending upon the legal speed limit, according to an embodiment of the present invention.

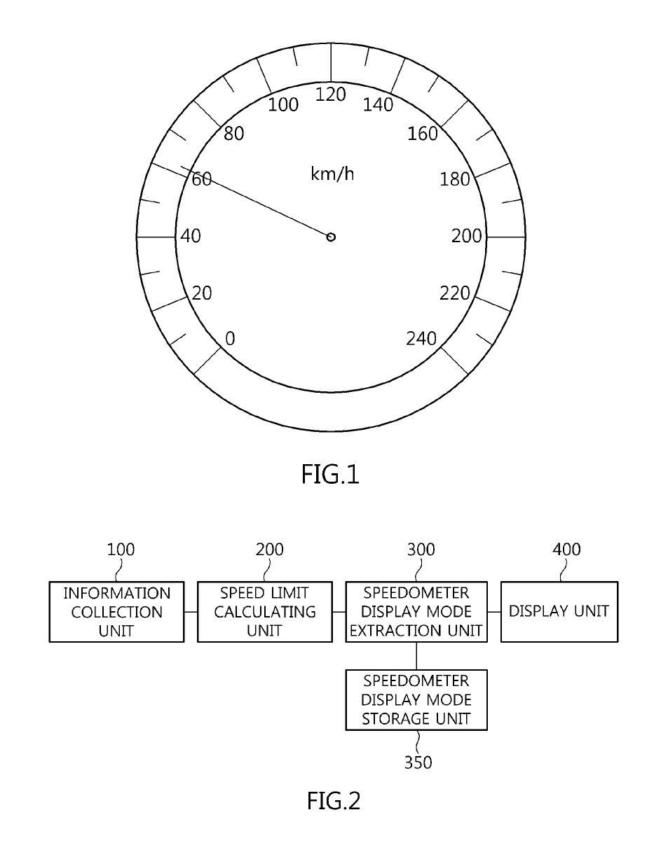

### DESCRIPTION OF SPECIFIC EMBODIMENTS

Exemplary embodiments of the present invention will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

An apparatus and method for controlling a speedometer for a vehicle according to an embodiment of the present invention will now be described in detail with reference to the accompanying drawings.

FIG. 2 is a block diagram illustrating the apparatus for controlling the speedometer according to the embodiment of the present invention.

First, the apparatus for controlling the speedometer includes an information collection unit 100, a speed limit calculating unit 200, a speedometer display mode extraction unit 300, a speedometer display mode storage unit 350, and a display unit 400.

The information collection unit 100 collects map information obtained from a device provided in a vehicle, information about the position of the vehicle, and base station information obtained from wireless communication. The map information is information about a map including a road on which the driving vehicle is positioned. In addition, the base station information is information about a base station which wirelessly communicates with the vehicle equipped with the apparatus for the present invention.

The speed limit calculation unit 200 calculates the legal speed limit of the vehicle currently driving on the road based on the result obtained by the information collection unit 100, that is, the map information, the information about the position, and the base station information. In this instance, the speed limit calculation unit 200 can extract the legal speed limit of the road of interest corresponding to the result obtained by the information collection unit 100 from an internal storage unit (not illustrated), in addition to the legal speed limit of the road based on the result obtained by the information collection unit 100.

The speedometer display mode extraction unit 300 extracts the speedometer display mode corresponding to the legal speed limit of the road of interest which is calculated by the speed limit calculation unit 200.

The speedometer display mode storage unit 350 includes a number of differently set speedometer display modes corresponding to every respective legal speed limit of the road. For example, the speedometer display mode set for every legal speed limit of the road includes an intermediate value (reference value), graduation marks and a background color which are differently set for every legal speed limit of the road, but the present invention is not limited thereto.

The display unit 400 automatically changes the speedometer display mode previously displayed on the dashboard of the vehicle to the speedometer display mode newly extracted from the speedometer display mode extraction unit 300 and provides a driver with it.

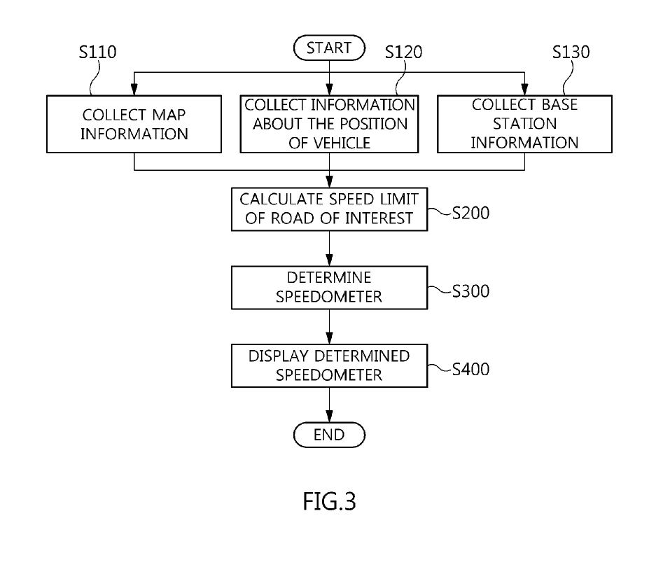

Next, a method for controlling the speedometer according to the present invention will be described in detail with reference to FIG. 3.

FIG. 3 is a flowchart illustrating the method for controlling the speedometer according to an embodiment of the present invention.

With reference to FIG. 3, the information collection unit 100 of the apparatus according to the present invention collects the map information that is able to be obtained from the vehicle (S110). In addition, the information collection unit 100 collects the information about the current position of the vehicle from a device, such as a navigation system, provided in the vehicle, that is, the information about the position of the vehicle (S120). Furthermore, the information collecting unit 100 collects the base station information through wireless communication between the vehicle and the base station with which the vehicle is associated (S130).

The speed limit calculation unit 200 of the apparatus according to the present invention calculates the speed limit of the road on which the vehicle is driving, based on the map information, the information about the position, and the base station information which are collected at steps S110 to S130 (S200).

The speedometer display mode extraction unit 300 of the apparatus according to the present invention determines the speedometer display mode corresponding to the legal speed limit of the road calculated at step S200, among the number of speedometer display modes which are differently set depending upon the legal speed limit of the road and stored in advance (S300).

The display unit 400 of the apparatus according to the present invention automatically changes the previously displayed speedometer display mode to the speedometer display mode determined at step S300 to display it (S400).

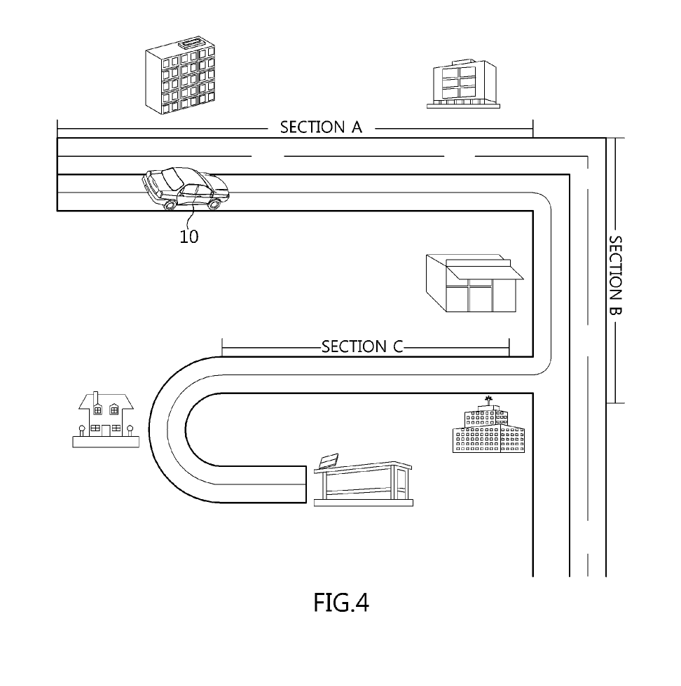

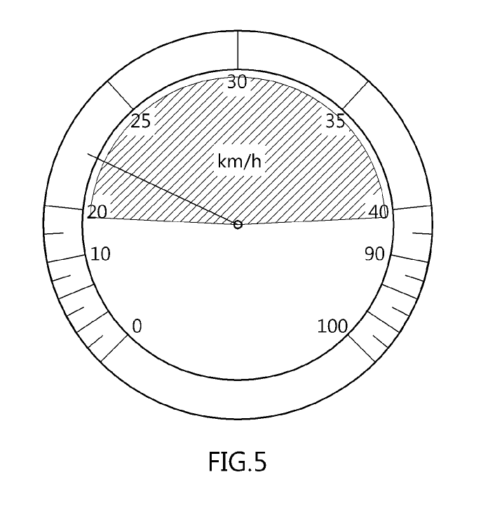

Next, an application to which the method for controlling the speedometer according to the embodiment of the present invention is applied will be described in detail with reference to FIGS. 4 to 7.

FIG. 4 is a diagram illustrating an application to which the method for controlling the speedometer according to the embodiment of the present invention is applied. In addition, FIGS. 5 to 7 are diagrams illustrating a speedometer of which a display mode is changed depending upon a legal speed limit, according to the embodiment of the present invention.

With reference to FIG. 4, a vehicle 10 drives in three sections of a road (section A, section B, and section C) having different legal speed limits. For example, the legal speed limit of section A is 30 km/h, the legal speed limit of section B is 60 km/h, and the legal speed limit of section C is 100 km/h.

The apparatus of the embodiment of the present invention provides the driver with a different speedometer display mode for each of the three sections in which the vehicle 10 drives.

More specifically, when the vehicle drives in section A, the speedometer display mode is provided as shown in FIG. 5. That is, the apparatus automatically changes the reference speedometer display mode to a speedometer display mode corresponding to an intermediate value (reference value) of 30 km/h to provide the driver with the newly changed speedometer display mode. The term ‘reference speedometer display mode’ means the previously displayed speedometer display mode. The speedometer display mode corresponding to the intermediate value of 30 km/h can be set such that the interval between graduation marks close to the intermediate value is wider while the interval of graduation marks far away from the intermediate value is narrower. Alternatively, the speedometer display mode may be provided with a different background color, which is indicated by a slash in FIGS. 5 to 7, on an inner portion of every graduation mark to show it, such that the driver can recognize the minimum speed, appropriate speed, and maximum speed for every section.

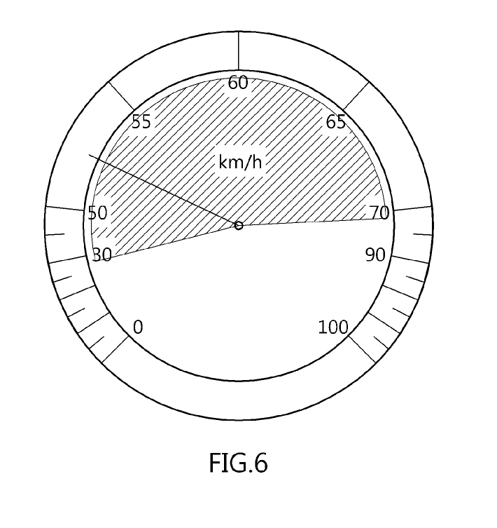

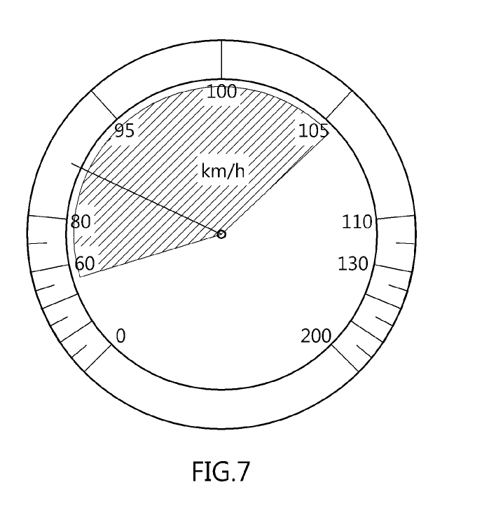

When the vehicle drives in the section B, the apparatus of the present invention provides the speedometer display mode illustrated in FIG. 6. In addition, when the vehicle drives in the section C, the apparatus of the present invention provides the speedometer display mode illustrated in FIG. 7.

With the apparatus for controlling the speedometer according to the embodiment of the present invention, the legal speed limit of the road on which the vehicle is driving is calculated based on the map information, the information about the position, and the base station information, and the driver is provided with the speedometer display mode corresponding so to the calculation result, it is possible to prevent the driver from driving beyond the speed of the intermediate value, thereby naturally following the legal speed limit.

While the present invention has been described with respect to the specific embodiments, it will be apparent to those skilled in the art that various changes and modifications may be made without departing from the spirit and scope of the invention as defined in the following claims.

What is claimed is:

1. An apparatus for controlling a speedometer for a vehicle, comprising:
an information collection unit configured to collect map information, information about the position of a vehicle, and base station information;
a speed limit calculation unit configured to calculate a legal speed limit of a road on which the vehicle is driving, based on the map information, the information about the position, and the base station information;
a speedometer display mode storage unit configured to store a number of differently set speedometer display modes for respective legal speed limits of the road;
a speedometer display mode extraction unit configured to extract a speedometer display mode corresponding to the calculated legal speed limit of the road among the number of differently set speedometer display modes; and
a display unit configured to automatically change a previously displayed speedometer display mode to the extracted speedometer display mode.

2. The apparatus for controlling the speedometer of claim 1, wherein the differently set speedometer display modes for respective legal speed limits of the road include different intermediate values.

3. The apparatus for controlling the speedometer of claim 1, wherein the differently set speedometer display modes for respective legal speed limits of the road include different intervals of graduation marks.

4. The apparatus for controlling the speedometer of claim 1, wherein the differently set speedometer display modes for respective legal speed limits of the road include different background colors.

5. The apparatus for controlling the speedometer of claim 1, wherein the map information is information about a map including a road on which the driving vehicle is positioned, and the base station information is information about a base station which wirelessly communicates with the vehicle.

6. A method for controlling a speedometer for a vehicle, comprising:
collecting map information, information about the position of a vehicle, and a base station information;
calculating a legal speed limit of a road on which the vehicle is driving, based on the map information, the information about the position, and the base station information;
extracting a speedometer display mode corresponding to the calculated legal speed limit of the road among the number of differently set speedometer display modes; and
automatically changing a previously displayed speedometer display mode to the extracted speedometer display mode.

7. The method for controlling the speedometer of claim 6, wherein the differently set speedometer display modes for respective legal speed limits of the road include different intermediate values.

8. The method for controlling the speedometer of claim 6, wherein the differently set speedometer display modes for respective legal speed limits of the road include different intervals of graduation marks.

9. The method for controlling the speedometer of claim 6, wherein the differently set speedometer display modes for respective legal speed limits of the road include different background colors.

10. The method for controlling the speedometer of claim 6, wherein the map information is information about a map including a road on which the driving vehicle is positioned, and the base station information is information about a base station which wirelessly communicates with the vehicle.
